(19) United States
(12) Patent Application Publication
(10) Pub. No.: US 2023/0011642 A1
(43) Pub. Date: Jan. 12, 2023

(54) Method, a system, a computer program product and a service for determining an intermediate product-specific sustainability indicator

(71) Applicant: UPM Raflatac Oy, TAMPERE (FI)

(72) Inventors: Robert TAYLOR, Kangasala (FI); Oona KOSKI, Tampere (FI); Sanna UOLAMO-UUSITALO, Lempäälä (FI)

(21) Appl. No.: 17/783,713

(22) PCT Filed: Mar. 3, 2020
(86) PCT No.: PCT/FI2020/050132

§ 371 Date: Jun. 9, 2022

(30) Foreign Application Priority Data
Dec. 31, 2019 (FI) 20196141

(51) Int. Cl. G06Q 30/00

(52) U.S. Cl. CPC G06Q 30/018

(57) ABSTRACT

The invention relates to a method, a system, a computer program product and a service for providing up-to-date and verified information of an intermediate product-specific sustainability indicator. The method comprises receiving a first input data (102, 202, 302) including internal information on the intermediate product, receiving a second input data (104, 204, 304) including external information on raw material(s) used for the intermediate product, processing at least the first input data (102, 202, 302) according to a life cycle assessment method in order to produce an intermediate product-specific life cycle parameter, processing at least the second input data (104, 204, 304) in order to produce an intermediate product-specific sustainability parameter, providing an intermediate product-specific sustainability indicator (108) comprising the intermediate product-specific life cycle parameter and the intermediate product-specific sustainability parameter, and associating the intermediate product-specific sustainability indicator (108) for the intermediate product.

### TECHNICAL FIELD

This specification relates to a method, a system, a computer program product and a service for providing up-to-date and verified information of an intermediate product-specific sustainability indicator. Particularly, the specification relates to a sustainability indicator which is based on a life cycle parameter and a sustainability parameter both specifically determined and verified for the given intermediate product in question. More particularly, the specification relates to intermediate product-specific sustainability indicator which in addition to life cycle assessment as one parameter includes also sustainability information as a further parameter related to the preservation of the ecosystem services for the particular ecosystem which has been involved for sourcing raw material(s) for the intermediate product in question.

### BACKGROUND

Life cycle assessment (LCA), also known as life cycle analysis, is a technique to assess environmental impacts associated with stages of the life cycle of a commercial product, process or service. More specifically, the term is applied to the techniques and methods by which the environmental impact of the product, process or service is determined, through a thorough inventory of the energy and materials that are brought into each, and the energy and materials related to each that are released into the environment. LCAs are typically performed as cradle-to-gate or cradle-to-grave analysis including relevant stages when converting raw materials into products.

LCA studies have confronted criticism for lack of consistency in the methods and assumptions used to track, for example, carbon during the product life cycle. LCA studies are, by their nature, limited to providing evaluation of the phases taking place in the so-called technosphere, i.e. evaluation of the phases that take place after the raw materials have already been extracted from nature.

In order to have a complete view on environmental impact, effects taking place both in the technosphere as well as remaining biosphere should be taken into account. Without this the selection of products having truly the lowest environmental impact is either very challenging or uncertain.

The challenges in traditional LCA studies are further complicated by the fact that the manufacturing of goods often involve use of intermediate products, which require further processing before being saleable to the customer or finally to the ultimate consumer. This further processing may be done by the original producer or by another producer. Thus, an intermediate product may be a final product for one company and an input for another company that produces the final product for the consumer.

Currently, there is no method or system available for providing up-to-date and verified information of the overall environmental impact of a specific intermediate product in a manner that allows in a business-to-business relationship the companies to easily communicate and compare individual intermediate products for their respective overall impact. This hinders companies that are using intermediate products in their own production to use such information in their own respective calculations and providing the results in easy verified manner to their own customers or consumers.

In addition, existing LCAs concentrate mainly on effects taking place in the technosphere and therefore they do not provide truly quantified, product-specific information on the effects taking place in these ecosystem services that have been utilized in raw material extraction.

### SUMMARY

It is an aim of this specification to provide intermediate product-specific information on environmental impact of the intermediate product. The provided intermediate product-specific sustainability information may enhance traceability, information and/or verification of environmental aspects of the intermediate product.

According to an embodiment, a method for determining a sustainability indicator for an intermediate product is provided. The method comprises
receiving a first input data including internal information on the intermediate product,
receiving a second input data including external information on raw material(s) used for the intermediate product,
processing at least the first input data according to a life cycle assessment method in order to produce an intermediate product-specific life cycle parameter,
processing at least the second input data in order to produce an intermediate product-specific sustainability parameter,
providing an intermediate product-specific sustainability indicator comprising the intermediate product-specific life cycle parameter and the intermediate product-specific sustainability parameter, and
associating the intermediate product-specific sustainability indicator for the intermediate product.

According to an embodiment, a system for determining a sustainability indicator for an intermediate product is provided. The system comprises
means for receiving a first input data including internal information on the intermediate product,
means for receiving a second input data including external information on raw material(s) used for the intermediate product,
means for processing at least the first input data according to a life cycle assessment method in order to produce an intermediate product-specific life cycle parameter,
means for processing at least the second input data in order to produce an intermediate product-specific sustainability parameter,
means for providing an intermediate product-specific sustainability indicator comprising the intermediate product-specific life cycle parameter and the intermediate product-specific sustainability parameter, and
means for associating the intermediate product-specific sustainability indicator for the intermediate product.

According to an embodiment, a system for determining a sustainability indicator for an intermediate product is provided. The system comprises
an arrangement configured to receive a first input data including internal information on the intermediate product,
an arrangement configured to receive a second input data including external information on raw material(s) used for the intermediate product;
an arrangement configured to process at least the first input data according to a life cycle assessment method in order to produce an intermediate product-specific life cycle parameter,
an arrangement configured to process at least the second input data in order to produce an intermediate product-specific sustainability parameter,
an arrangement configured to provide an intermediate product-specific sustainability indicator comprising the intermediate product-specific life cycle parameter and the intermediate product-specific sustainability parameter, and
an arrangement configured to associate the intermediate product-specific sustainability indicator for the intermediate product.

According to an embodiment, a computer program product for determining a sustainability indicator for an intermediate product is provided. The computer program product comprises a computer code, wherein said computer code when executed by a processor causes a system at least to perform:
receive a first input data including internal information on the intermediate product,
receive a second input data including external information on raw material(s) used for the intermediate product,
process at least the first input data according to a life cycle assessment method in order to produce an intermediate product-specific life cycle parameter,
process at least the second input data in order to produce an intermediate product-specific sustainability parameter,
provide an intermediate product-specific sustainability indicator comprising the intermediate product-specific life cycle parameter and the intermediate product-specific sustainability parameter, and
associate the intermediate product-specific sustainability indicator for the intermediate product.

According to an embodiment, a computer program product for determining a sustainability indicator of an intermediate product is provided. The computer program product comprises executable instructions when executed by a processor are configured to:
receive a first input data including internal information on the intermediate product,
receive a second input data including external information on raw material(s) used for the intermediate product,
process at least the first input data according to a life cycle assessment method in order to produce an intermediate product-specific life cycle parameter,
process at least the second input data in order to produce an intermediate product-specific sustainability parameter,
provide an intermediate product-specific sustainability indicator comprising the intermediate product-specific life cycle parameter and the intermediate product-specific sustainability parameter, and
associate the intermediate product-specific sustainability indicator for the intermediate product.

According to an embodiment, a service for determining a sustainability indicator of an intermediate product is provided. The service utilizes the method as disclosed herein, and the service comprises associating a unique code with the intermediate product.

### BRIEF DESCRIPTION OF THE DRAWINGS

FIG. 1a illustrates, by way of an example, a schematic representation of a method according to an embodiment,

FIG. 1b illustrates, by way of an example, a schematic representation of a method according to an embodiment,

FIG. 2a illustrates, by way of an example, a schematic representation of a method for determining an intermediate product-specific life cycle parameter,

FIG. 2b illustrates, by way of an example, a schematic representation of a method for determining an intermediate product-specific life cycle parameter, and

FIG. 3 illustrates, by way of an example, a system according to an embodiment.

The figures are schematic. The figures are not in any particular scale.

### DETAILED DESCRIPTION

The solution is described in the following in more detail with reference to some embodiments, which shall not be regarded as limiting.

Within context of this specification, terms “information” and “data” are used as synonyms.

Within context of this specification cradle-to-grave LCA is considered to be the full Life Cycle Assessment from resource extraction, “cradle”, to use of the resources until the final disposal phase, “grave”. For example, wood extracted from a forest are used to produce paper, which can then be recycled into low-energy production cellulose insulation and then used as an energy-saving device in the ceiling of a home for 50 years. After 50 years the cellulose fibres are replaced and the old fibres are disposed of, possibly incinerated. All inputs and outputs are considered for all the phases of such life cycle.

Within context of this specification cradle-to-gate LCA includes life cycle stages from extraction or acquisition of raw materials to the point at which the product leaves the organization undertaking the assessment. Thus, the cradle-to-gate LCA is an assessment of a partial product life cycle from resource extraction (cradle) to the factory gate (i.e., before it is transported to the customer company or final consumer). The use phase and disposal phase of the product are omitted in this case. Cradle-to-gate LCA may be used especially for intermediate products, the definition for those given below.

Within context of this specification, intermediate product means a producer goods which can be used in further manufacturing, processing, or resale. Producer goods either become part of the final product or lose their distinct identity in the manufacturing stream leading to a final product. Intermediate products or producer goods are typically used in business-to-business activities and can be mechanical or chemical materials or components that will become converted, integrated or blended into a final product.

An intermediate product is a product that might require further processing before it is saleable to the ultimate consumer. This further processing might be done by the producer or by another processor or in some cases by the consumer itself. Thus, an intermediate product might be a final product for one company and an input for another company that produces the final product. This means intermediate products or goods are resold among industries.

Intermediate products or goods generally can be made and used in three different ways by a company. Firstly, a company can make and use its own intermediate goods. Secondly, a company can manufacture intermediate goods and sell them to others. Thirdly, a company can buy intermediate goods to produce either secondary intermediate goods or final goods.

Within context of this specification ecosystem services are understood to cover the benefits provided by the natural environment and ecosystem. Ecosystem services are integral to the provisioning of raw materials and clean water originating from nature, the decomposition of waste and pollutants and resilience and productivity of new biomaterials such as for example wood or food. Often, the ecosystem services are grouped into four main categories: provisioning, such as the production of raw materials, food and water; regulating, such as the control of climate and disease; supporting, such as nutrient cycles and oxygen production; and cultural, such as spiritual and recreational benefits.

The ecosystem services relevant for this disclosure are the ones which may be quantified and preferably expressed as numerical values. Such ecosystem services may relate to, for example, carbon sequestration relating to the carbon stock remaining in the forest after logging or other biomass extraction, biodiversity or generation/regeneration of pure groundwater.

The disclosure provides a new approach which ensures up-to-date and verified information on product-specific level via a sustainability indicator, which comprises quantified information both from product-specific life cycle assessment as well as quantified and product-specific information on sustainability effects for the particular ecosystem involved when sourcing the raw material(s) for the product. The product being an intermediate product, the disclosure further solves the typical challenges in selecting a component or product with the truly lowest overall environmental impact and provides further a systematic approach to convey the quantified information to the next producer and/or to the final customer/consumer.

The disclosure provides an approach which for the first time, in a verified and quantified manner, combines life cycle assessment results arising from technosphere related actions with the relevant effects taking place in the biosphere related to ecosystem services, and does this on product-specific manner.

Examples of Intermediate Products

Some examples of intermediate products for which the solution may be applied to are given below as non-limiting examples.

Bio-based monomers or polymers originating from non-fossil raw materials. These can be further used as components or intermediate products towards higher grade bio-based chemicals, plastics or fuels. Such bio-based products may further be blended with materials arising from fossil sources and the sustainability indicator may be calculated for the final products.

For example, solid wood or other wood or forest originating raw materials may be converted into the following biopolymers or materials: bio-monoethylene glycol (BioMEG), lignin-based renewable functional fillers, bio-monopropylene glycol (BioMPG) or industrial sugars. These can be further used as raw materials for textiles, polyester products such as PET bottles, packaging, deicing fluids, composites, pharma, cosmetics or detergents.

For example, residues from pulp production process may be converted into bio-based naphtha, which can be further used to manufacture bio-based polypropylene film. Such bio-based film may be further used as label or packaging film. Bio-based polymers may also be used to produce bio-based adhesives, such as pressure sensitive adhesives for label use.

Wood originated materials can be used, for example, as veneer for making plywood materials or other advanced timber materials. The bonding solutions, adhesives, used for producing plywood or other timber materials may be bio-based. For example bio-based lignin can be used in the adhesives for the production of plywood or other wood construction materials. The lignin may be obtained as a by-product generated during the kraft pulping process and the wood for this may be harvested from sustainably cared forests.

One category of intermediate products which need to be evaluated for their sustainability are wood fibre containing products. Within this category exist various cardboard or paper materials for packaging, communication or other end uses. A specific subcategory are special cardboard or paper materials containing specific coating or internal layers providing, for example, advanced barrier properties. Such materials are typical, for example, in food packaging. Traditionally, addition of non-fossil layers into such wood fibre containing products has affected their true sustainability value. The solution provided in this disclosure may be used to compare such intermediate products in a verified and clear numerical manner leading into better overall comparison from the sustainability point of view when new materials are developed and become available.

Forest originated materials can be used for intermediate products for biomedical products, for example pharmaceutical biochemicals, cell growing or wound healing materials. These may involve, for example, bio-based hydrogels or chemicals extracted from wood and sourced from sustainable and responsibly managed forests.

Examples of Label Products

In the following more elaborated examples are given for label materials. These materials are intermediate products, which can be converted through printing and die-cutting into labels, which are then used as information carrying component in different type packages or logistic applications.

A label is a piece of material to be applied onto articles of different shapes and materials. A label comprises at least a face material also referred to as a face stock or a face. A typical way to adhere the label onto an article is by use of adhesive. The label comprising an adhesive layer is referred to as an adhesive label. The adhesive may comprise pressure sensitive adhesive. A label comprising pressure sensitive adhesive may be referred to as a pressure sensitive adhesive (PSA) label. Pressure sensitive adhesive labels may also be referred to as self-adhesive labels.

Face refers to a top substrate of the label, also called as a face stock or a face material. In case of a plastic face material it may also be called a face film. The face may have a monolayer or multilayer structure comprising at least two layers. The face is the layer that is adhered to the surface of an article during labeling through an adhesive layer. The face comprises an adhesive side and a print side. A combination comprising a face and adhesive may be referred to as an adhesive label. The face may comprise e.g. print in order to provide information and/or visual effect. Further, the label may contain additional layers, for example top coatings or overlaminates to protect the top surface and/or print of the label against rubbing or other external stress. Coating or additional layers, like a primer, may enable enhancing compatibility of adjacent layers or parts of the label, for example adhesion between the layers.

Release liner refers to a structure comprising a substrate and a release layer on a surface of the substrate contacting the adhesive in a label laminate. The substrate may also be called a backing material. The release liner may comprise a release agent, for example a silicone or non-silicone based agent. The release agent is a chemical having low surface tension. The release agent may be used in order to prevent other materials from bonding to it and to provide a release effect. Release liners of the label laminates may serve one or more useful functions: they may be used as a carrier sheet onto which the adhesive is coated; they may protect the adhesive layer during storage and transportation; they may provide a support for labels during die-cutting and printing, and ultimately they may provide the release substrate carrying the labels for dispensing onto the items to be labeled.

Label laminate, also referred to as an adhesive label laminate refers to a product comprising a face, adhesive and a release liner. In the label laminate the face is laminated together with the release liner having the adhesive in between. The label laminate may be a continuous structure from which the individual labels may be die-cut. The release liner of the label laminate is typically removed prior to labeling i.e. attaching the label onto the surface of an item to be labeled.

The manufacturing process of label laminates and labels thereof typically comprises steps of providing a face stock and a release liner, applying an adhesive layer onto a surface of the face stock and/or onto a surface of the release liner and laminating the face stock with the release liner in such a way that the adhesive layer is arranged in between the face stock and the release liner in order to form a label laminate.

The label laminate may be converted, i.e. individual labels may be cut from the label laminate structure. After cutting, the labels may remain to be attached to a common release liner (i.e. the release liner remains uncut). Thus, a plurality of labels mat remain to be attached to a common continuous release liner. This may be called a converted label web. Alternatively, the labels may be completely separate (i.e. also the release liner may be cut).

In the lamination process so-called machine rolls, the width of the rolls corresponding to the width of the manufacturing/laminating machine, are typically formed. The machine rolls may be slit, i.e. cut lengthwise to so-called customer rolls with smaller widths. The slitting involves typically unwinding the machine roll, then slitting the web and again winding the narrower webs into individual customer rolls. Alternatively, the slitting into customer rolls may be performed as a part of the label lamination process as an in-line process, or it may even be performed as part of the label laminate converting process, wherein the label laminate is die-cut (kiss cut) to form individual labels carried by continuous release liner.

The label may also be a so-called linerless label. The linerless label comprises a face and an adhesive on the face. Alternatively the label may be a so-called shrink label, where heat shrinkable polymeric face material(s) are seamed and rolled on or sleeved around labeled articles and shrunk around the items. Shrinkable labels may comprise additionally some pressure sensitive adhesive(s) or those may be produced completely without pressure sensitive adhesive, or even without seaming adhesive.

Labels may be used in wide variety of labeling applications and end-use areas, such as labeling of food, home and personal care products, industrial products, pharmaceutical and health care products, beverage and wine bottles, other consumables etc. Labels enable providing information, like product specification, on the labeled product(s). Information, e.g. print of a label, may comprise human-readable information, like image(s), logo(s), text, and/or machine-readable information, like bar code(s), QR (Quick Response) code(s).

Depending on the label end use in question, the face, adhesive, release and liner materials of the label are to be selected to be suitable for the given end use. This selection and thus the specific label structure, or label specification, has effect on the intermediate product-specific life cycle parameter.

Further, the origin of raw materials used in different components of the label has effect on the intermediate product-specific sustainability parameter or parameters. One such sustainability parameter is a carbon sequestration relating to the carbon stock remaining in the forests used to harvest the wood raw materials. The intermediate product-specific life cycle parameter and the intermediate product-specific sustainability parameter together form an intermediate product-specific sustainability indicator. The intermediate product-specific sustainability indicator provides information on product's integral impact on environment. The provided information is useful in comparing alternative products and their integral impact on environment. The intermediate product-specific sustainability indicator is based on selection and origin of the raw materials. Changes in the raw material information cause updates to the intermediate product-specific sustainability indicator.

This specification relates to a method, a computer program product, a system and a service for providing up-to-date and verified information of an intermediate product-specific sustainability indicator for an intermediate product. The intermediate product-specific sustainability indicator is formed based on the intermediate product-specific sustainability parameter and the intermediate product-specific life cycle parameter.

The method, system, computer program product and service are arranged to take into account internal information on the intermediate product and raw material information from external supplier(s). Further, the same may be arranged to communicate with an external verifier body in order to provide verified information on an intermediate product-specific sustainability parameter.

The product-specific sustainability indicator may indicate or relate for example to carbon sequestration, fresh water usage, waste treatment, biodiversity or energy consumption.

Internal Information on the Intermediate Product

Internal information on the intermediate product includes intermediate product-specific details of the materials, i.e. the components and the compositions of them, as well as details relating to the manufacturing of the intermediate product.

Internal information on the intermediate product, the intermediate product being a label, includes label product-specific details of a face material, adhesive, release liner and/or a release coating, as well as details relating to the production of the label product, as discussed above. Specifically, the information includes compositions of the face material, release liner, adhesive and/or release coating. The information may relate to the monomers that are used for producing polymers, from which polymers the face material, release liner, adhesive and/or the release coating are produced.

As mentioned above, components of the label product, i.e. the face, adhesive, release and/or liner, are selected so as to be suitable for a given end use. This selection thus provides a specific label structure, or a label specification. Each label product have their own, specific combination of the materials. Term label product herein refers to a batch of labels having the same or similar characteristics. The label product may comprise an individual label; or a shipment-, a roll- or a product lot of labels.

Further, internal information on the label product includes physical parameters relating to the face, adhesive, release and/or liner materials. These physical parameters may include for example thickness of the adhesive layer, grammage of the face stock etc. For example a thinner layer of the adhesive may shorten the drying process of the adhesive, and thus may have effect on the energy consumption positively, i.e. by decreasing it. A lower grammage of the face stock may utilize less fibre material, and thus effect positively to the sustainability indicator of a product utilizing such.

Internal information relating to the label product manufacturing includes data regarding for example use of energy, use of water and carbon dioxide (CO₂) emissions in producing the label product from its components, i.e. the face, adhesive, release and/or liner. Producing the label products may include for example coating, drying, laminating, slitting and die-cutting. Different label products and components have their own process parameters that are included in the internal information.

In some cases, the components of the intermediate product may be produced internally, and thus the internal information on the intermediate product may also include data regarding for example use of energy, use of water and CO₂ emissions in manufacturing the components of the intermediate product from raw materials.

Label products referred to within context of this specification may have paper-based face material and/or paper-based release liner. Label products referred to within context of this specification may have wood-based adhesive.

All or some raw materials used for components of an intermediate product may be originating from renewable sources, for example forests. Such renewable components may be sourced from forests or other sources in different manners, preferably in a manner enabling maintaining or even improving capability of the sources in order to counteract possible negative environmental impacts. Examples of such counteraction are carbon dioxide sequestration relating to the carbon stock remaining in a source or forest, capability to clean and produce pure groundwater or improve species biodiversity. Such positive indications due to the selection of the raw material and sources are taken into account in calculations of the intermediate product-specific sustainability parameter and -indicator.

All or some raw materials used for the components of an intermediate product may comprise post-consumer recycled materials. Post-consumer recycled materials may refer to waste that individuals routinely discard, for example in a waste receptacle or a dump.

Raw Material Information on the Intermediate Product from External Supplier(s)

Raw material information includes data on source(s) of the material(s).

Raw material information includes at least information regarding use of energy, use of water and CO₂ emissions in external manufacturing of the raw materials. In some cases, the components of the intermediate product, i.e. the face, adhesive, release and/or liner in case of a label product, are produced externally from the raw materials, and thus the raw material information may also include information regarding for example use of energy, use of water and CO₂ emissions in manufacturing the components of the intermediate product from raw materials, such as above described components of the label products, as well as in their transportation to the intermediate product producing site.

In a case the intermediate product-specific sustainability parameter to be determined is carbon sequestration, the raw material information may include information on source forest(s) and fibre of for example the paper material of the label or any other intermediate product. Specifically the raw material data may include countries of origin, climate region and location, certification data (such as FSC, PEFC, SFI, ISCC and other similar chain of custody or traceability certifications), share of fibres originating from each country, tree species, ratio of hardwood/softwood and total merchantable wood removals m³/ha.

Life Cycle Parameter

Within context of this specification, the typical model utilized for determining life cycle parameter is a so-called cradle-to-gate LCA. Alternatively, the model utilized for determining life cycle parameter may be a cradle-to-grave LCA. The cradle-to-gate LCA is an assessment of a partial intermediate product life cycle from resource extraction (cradle) to the factory gate (i.e. before the intermediate product is transported). The use phase and the disposal phase of the intermediate product are omitted in this case. However, the provided information may be used for determining corresponding information for the later phases as well, leading towards whole intermediate product life cycle assessment(s). The provided partial intermediate product life cycle parameter enables determining corresponding information for end products of different types.

The model utilized for determining the life cycle parameter is based on a LCA study performed in accordance with ISO14040/44 standards and PAS2050 standard.

The model takes into account use of energy, use of water and CO₂ emissions in the life cycle of an intermediate product from raw materials to the manufacturer's gate. CO₂ emissions include emissions originating from raw materials, product manufacturing and transportation. Besides primary energy, freshwater consumption and global warming potential, the model may take into account acidification potential, eutrophication potential, particulate matter/respiratory inorganics and photochemical ozone creation potential as environmental indicators. The ecosystem services relevant for determining environmental indicators may be any of the ones that can be quantified and expressed as numerical values.

The LCA model takes into account the internal information on the intermediate product, as well as the raw material information from external supplier(s). Thus, whereupon the intermediate product is a label product, the data for the LCA model include for example compositions of the face material, release liner, adhesive and release layer, as well as their transport to the manufacturing site. Also, consumption of tap water, electricity and thermal energy as well as discharge as municipal waste water in the manufacturing process may be taken into account. Further, the cradle-to-gate LCA model may take into account packaging of the manufactured intermediate product and production waste disposal as well as the transportation relating to it. Different intermediate products have their own process parameters that effect the life cycle parameter of the intermediate products.

The LCA as described may be used as an intermediate product-specific life cycle parameter, or modified in order to form an intermediate product-specific life cycle parameter. The life cycle parameter is utilized for providing an intermediate product-specific sustainability indicator.

Sustainability Indicator

The intermediate product-specific sustainability parameter, which is determined based on the raw material sourcing, may refer for example to carbon sequestration, groundwater reservation or generation or recharge. On the other hand the life cycle parameter for an intermediate product may refer for example to carbon release, energy or water consumption. The two parameters may be combined in order to produce an intermediate product-specific sustainability indicator. The intermediate product-specific sustainability indicator provides a clear and comprehensive intermediate product-specific information on environmental impact of the intermediate product. The intermediate product-specific sustainability indicator provides meaningful and understandable way of comparing the actual long term environmental impacts between alternative intermediate products.

Further, for an intermediate product, like a label, the integral sustainability indicator may help to determine the final impact of the final product, which employs the intermediate product. For example, the label is only a part of the final (labeled) product and its life cycle.

In a case the intermediate product-specific sustainability parameter to be determined and provided is carbon sequestration, established, up-to-date scientific data is taken into account. The scientific data may be established for example by the IPCC (Intergovernmental Panel on Climate Change). For example, IPCC provides the ratios of wood between crown, wood plus bark, and roots. Also, IPCC provides guidance on harvest loss for the wood plus bark portion, such that for each tree species it is possible to determine the percentage of mass (m-%) that remains in the forest to become dead organic matter and the percentage of mass (m-%) that is taken from the forest and used by a forest industry entity.

It is thus possible to calculate per species/location the CO₂ sequestered in the forest per hectare (ha) and the amount of CO₂ the forest industry entity removes and stores per hectare (ha). These two are utilized to determine intermediate product-specific results.

Forest industry entity refers to an entity that may be responsible for at least one of the following: owning the forest, harvesting the forest, processing the harvested trees to fibres, manufacturing paper from the processed fibres.

FSC certified forests have certain requirements to ensure they achieve the FSC certification. The main requirements include: no deforestation, 5-10% of forest to be full grown trees and buffer zones (˜25%). These requirements are taken into account when determining the carbon sequestration for an intermediate product, such as a label, wherein the paper material originates from FSC certified forest(s).

The carbon sequestration determinations take into account a biomass remaining in the forest after harvest (tonnes dm/ha harvested). This may be calculated by determining biomass growth above and below ground (tonnes dm/ha harvested) and subtracting from it total merchantable wood leaving the forest (tonnes dm/ha harvested).

Further, percentage of carbon retained in dead organic matter residing in the forest, up to and after a 100 year horizon is taken into account. Thus, the amount of biomass left in the forest after removals and biomass released, i.e. the biomass remaining in the forest after 100 years, is accounted. By converting this to tonnes carbon/ha, the carbon sequestration after the removals and emissions may be determined. The horizon may be chosen to be different for different tree species. The horizon may be for example 40, 60, 75 or 80 years.

Basically the carbon sequestration is first determined as carbon sequestration left in the forest (in tCO₂e/ha). This value is then converted to functional unit (kgCO₂e/1000 m²). The conversion is implemented by calculating a conversion factor for forest area per label component (ha/kg of pulp), converting the conversion factor to functional unit per label component (1000 m²/ha) and applying the conversion factor to the specific sourcing forest in order to convert to carbon sequestration per functional unit (kgCO₂e/1000 m²). Finally, the carbon sequestered in the forest is apportioned to the intermediate product based on the intermediate product components (kgCO₂e/1000 m²).

Method and System

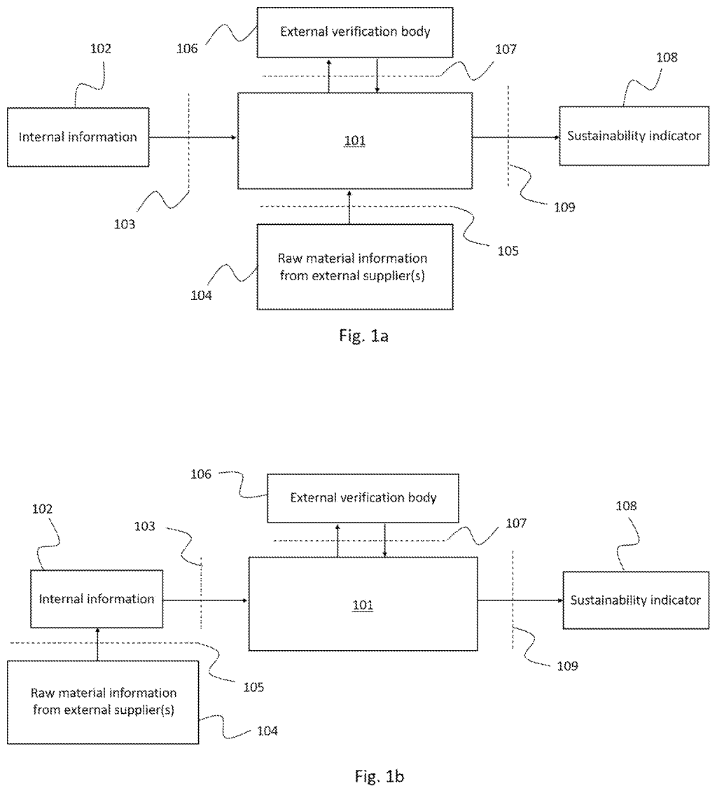

According to an embodiment and as illustrated in FIGS. 1a and 1b, a method for determining a sustainability indicator of an intermediate product is provided. The method comprises receiving a first input data 102 and a second input data 104.

The method comprises processing at least the first input data 102 according to a life cycle assessment method in order to produce an intermediate product-specific life cycle parameter. This is implemented at a system 101. The life cycle assessment method may be externally approved.

The method comprises processing at least the second input data 104 in order to produce an intermediate product-specific sustainability parameter. This may be implemented at a system 101. Alternatively, processing of at least the second input data 104 may comprise transmitting at least the second input data 104 to an external verification body 106 for processing, and receiving the intermediate product-specific sustainability parameter as a response from the external verification body 106. The intermediate product-specific sustainability parameter, whether being produced internally by the system 101 or by the external verification body, is nevertheless produced according to a verified and approved process.

The method comprises providing an intermediate product-specific sustainability indicator 108 comprising the intermediate product-specific life cycle parameter and the intermediate product-specific sustainability parameter, and associating the intermediate product-specific sustainability indicator 108 for the intermediate product. This is implemented at a system 101.

The first input data 102 may include internal information on the intermediate product as described above. According to an embodiment, the first input data 102 comprises information on at least one of: materials, manufacturing process phases, manufacturing parameters, physical parameters of the components of the intermediate product.

The second input data 104 may include raw material information on the intermediate product from external supplier(s), as described above. According to an embodiment, the second input data 104 comprises information on at least one of: geographical origin, type, manufacturing process phases of raw material.

As mentioned, at least the first input data 102 may be processed in accordance to an externally approved life cycle assessment method in order to produce an intermediate product-specific life cycle parameter. The LCA method may use the model performed in accordance to ISO14040/44 and PAS2050 standards. This is implemented at a system 101.

According to an embodiment, at least the second input data 104 is transmitted to an external verification body 106 for processing. The external verification body 106 produces an intermediate product-specific sustainability parameter based on the received at least second input data 104. The external verification body 106 provides the intermediate product-specific sustainability parameter to the system 101.

FIG. 1a illustrates a method, wherein raw material information from external supplier(s) 104 comprises information on supplied components. Whereupon the intermediate product is a label product, the supplied components may include one/more layer(s) of a face, a release liner substrate, silicone, adhesive, coating material, or alike. The internal information 102 on the label product may include information regarding for example use of energy, use of water and CO₂ emissions in manufacturing the label product from its components, as supplied.

FIG. 1b illustrates a method, wherein raw material information from external supplier(s) 104 comprises information on supplied material(s) for manufacturing, refining, converting or upgrading components. Whereupon the intermediate product is a label product, the components may include one/more layer(s) of a face, a release liner substrate, silicone, adhesive, coating material, or alike. At least one of the components of the intermediate product are produced internally, and thus the internal information 102 on the intermediate product may also include information regarding for example use of energy, use of water and CO₂ emissions in manufacturing the component(s) of the intermediate product. The internal information 102 further comprises information regarding for example use of energy, use of water and CO₂ emissions in manufacturing the intermediate product; taking into account the same for the component(s), which is at least partly based on the supplier provided raw material data 104 of the component(s). Thus, raw material information 104 from external supplier(s) may be taken into account as part of the internal information 102 of the intermediate product.

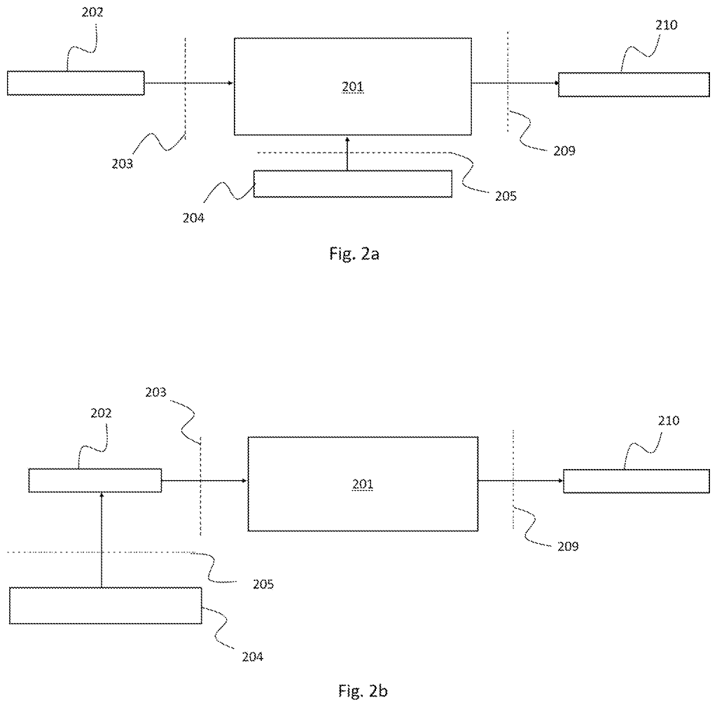

According to an embodiment, and as illustrated in FIGS. 2a and 2b, the method comprises processing at least the first input data 202 so as to determine an intermediate product-specific life cycle parameter 210. The method may include processing the second input data 204 with the first input data 202 so as to determine the intermediate product-specific life cycle parameter. The processing is implemented in the system 201. The life cycle parameter is determined in accordance to a predetermined model. The intermediate product-specific life cycle parameter 210 and the intermediate product-specific sustainability parameter are arranged to form an intermediate product-specific sustainability indicator 108, which may be associated and transmitted with the intermediate product.

The method may comprise associating and transmitting the received intermediate product-specific sustainability indicator 108 with each intermediate product.

According to an embodiment, the system 101 processes at least the second input data 104, optionally with the first input date 102, by apportioning carbon sequestered in the forest to the intermediate product. The system 101 may be arranged to ground processing of the second input data 104 and optionally the first input data 102, on up-to-date, established scientific data.

According to another embodiment, the system 101 is arranged to transmit at least the second input data 104, and optionally the first input data, to an external verification body 106 for processing. The external verification body 106 is arranged to process at least the transmitted second input data 104, optionally with the first input data 102, by apportioning carbon sequestered in the forest to the intermediate product. The external verification body 106 may be arranged to ground processing of the transmitted second input data 104 and the first input data 102, if transmitted, on up-to-date, established scientific data.

As illustrated by FIGS. 1a, 1b, 2a and 2b, the first input data 102, 202 may be received via a first communication interface 103, 203 and the second input data 104, 204 via a second communication interface 105, 205. The data may be transmitted to and/or received from the external verification body 106 via a third communication interface 107, 207. Further, the intermediate product-specific sustainability indicator 108 may be transmitted via a fourth communication interface 109, 209.

According to an embodiment, the first input data 102, 202 and/or the second input data 104, 204 is received via one of: wireless or wired communication link, internet, radio network access, application program interface. The data may be transmitted to and/or received from the external verification body 106 via one of: wireless or wired communication link, internet, radio network access, application program interface. The communication interfaces 103, 203, 105, 205, 107, 207, 109, 209 may be of the same, similar or a different kind.

The method may further comprise receiving a first input data including internal information on a second intermediate product, receiving a second input data including raw material information on the second intermediate product from external supplier(s); and transmitting at least the first input data, optionally with the second input data, to an external verification body for processing, receiving an intermediate product-specific sustainability parameter for the second intermediate product as a response from the external verification body. The method further includes processing at least the first input data according to an externally approved life cycle assessment method in order to produce an intermediate product-specific life cycle parameter for the second intermediate product, and forming the second intermediate product-specific sustainability indicator based on the intermediate product-specific sustainability parameter and intermediate product-specific life cycle parameter of the second intermediate product. The received intermediate product-specific sustainability indicator is associated with the second intermediate product. Alternatively, as described above, the data may be processed without using external verification body in order to produce the intermediate product-specific sustainability parameter.

A comparison between the intermediate product-specific sustainability indicator of the first intermediate product and the intermediate product-specific sustainability indicator of the second intermediate product may be provided. This enables providing comparison information between two or more different intermediate products correspondingly. This may be advantageous e.g. to a (potential) intermediate product purchaser so as to enable the purchaser to compare the environmental impacts of the intermediate products and to choose the most suitable for the given purpose.

The disclosed solution provides a possibility to express the sustainability indicator as numerical values separately for the life cycle parameter (technosphere related information/impact) as well for the sustainability parameter (biosphere related information/impact). However, such numerical values, for example related to carbon emissions (life cycle parameter) and carbon sequestration (sustainability parameter) may be difficult to put into perspective for a person not specially skilled in such concepts. Therefore, the values or the difference between two products may be expressed using equivalents. Such equivalents can be anything that a person can easily identify with and correlate with the environmentally positive effects (“environmental savings”) achieved by making the selection towards the product with better sustainability indicators. Examples of such equivalents expressed as comparable “environmental savings” may be but are not limited to: kilometres traveled by a car, train or aeroplane; number of domestic or continental flights; months of heating a family house; production of pieces items; production of kilograms of food, saving hectares of forest, compensating of emissions caused by family pets etc. One equivalent expression indicating in practise the carbon sequestration in a forest and by individual trees is the so called “Carbon Tree” visualization which indicates a real time carbon flow of an existing individual tree located at Hyytiälä environmental measurement station, Finland (http://www.hiilipuu.fi/).

According to an embodiment, a system for providing up-to-date and verified information of an intermediate product-specific sustainability indicator for an intermediate product is provided. The system may further provide an intermediate product-specific sustainability parameter and an intermediate product-specific life cycle parameter, and optionally a balance between the two. The system is arranged to receive internal product specification and data as first input, as well as to receive raw material data from external supplier(s) as second input. The system is arranged to process the first and the second inputs so as to determine an intermediate product-specific sustainability indicator. The system is arranged to process at least the first input data according to a LCA method in order to produce an intermediate product-specific life cycle parameter. The system is arranged to process at least the second input data in order to produce an intermediate product-specific sustainability parameter. The system may be arranged to transmit at least the second input data to an external verification body for processing. The system may be arranged to receive from the external verification body an intermediate product-specific sustainability parameter in response to transmitting at least the second input data. The system may be arranged to transmit the first and the second inputs to an external verification body for processing, to receive an intermediate product-specific sustainability parameter as a response data from the external verification body. The system is arranged to provide an intermediate product-specific sustainability indicator comprising the intermediate product-specific life cycle parameter and the intermediate product-specific sustainability parameter. The system is arranged to associate the intermediate product-specific sustainability indicator for the intermediate product.

The system is arranged to detect if contents of any of the inputs is altered and in response to a detected alteration, the system is arranged to trigger a determination of an intermediate product-specific sustainability indicator, -parameter and an intermediate product-specific life cycle parameter. The updated determination(s) is(/are) initiated in response to detection of change of any of the inputs. The change may be detected, if any of raw material data from an external supplier changes, if any of process parameters change, if manufacturing line or phases are changed, for example.

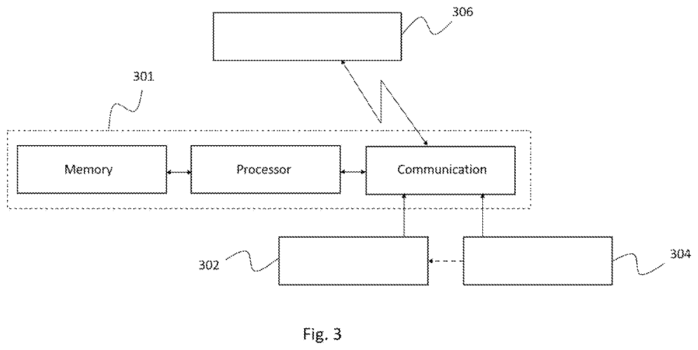

As illustrated by FIG. 3, the system 301 for determining a sustainability indicator of an intermediate product comprises at least one processor, at least one memory and at least one communication unit. The memory is configured to store information and executable instructions. The memory comprises means for storing information and executable instructions.

According to an embodiment, the system 301 for determining a sustainability indicator of an intermediate product comprises means for receiving a first input data 302, means for receiving a second input data 304. The system 301 comprises means for processing at least the first input data 302 according to a life cycle assessment method in order to produce an intermediate product-specific life cycle parameter. The system 301 comprises means for processing at least the second input data 304 in order to produce an intermediate product-specific sustainability parameter. The system 301 may comprise means for transmitting the first input data 302 and the second input data 304 to an external verification body 306 for processing, means for receiving an intermediate product-specific sustainability parameter as a response from the external verification body 306. The system comprises means for providing an intermediate product-specific sustainability indicator comprising the intermediate product-specific life cycle parameter and the intermediate product-specific sustainability parameter, and associating that for the intermediate product. The system may comprise means for transmitting the intermediate product and the associated data.

According to an embodiment, the system 301 comprises an arrangement configured to receive a first input data 302 and an arrangement configured to receive a second input data 304. The system 301 comprises an arrangement configured to process at least first input data according to a LCA method in order to produce an intermediate product-specific life cycle parameter. The system 301 comprises an arrangement configured to process at least the second input data 304 in order to produce an intermediate product-specific sustainability parameter. The system 301 may comprise an arrangement configured to transmit the first input data 302 and the second input data 304 to an external verification body 306 for processing, and an arrangement configured to receive an intermediate product-specific sustainability parameter as a response from the external verification body 306. The system 301 comprises an arrangement configured to provide an intermediate product-specific sustainability indicator comprising the intermediate product-specific life cycle parameter and the intermediate product-specific sustainability parameter, and an arrangement configured to associate the intermediate product-specific sustainability indicator with the intermediate product in order to be transmitted with the intermediate product.

According to an embodiment, the system 301 comprises means for performing the method as described above.

The system may comprise hardware based modules, like an electric circuit, an application specific integrated circuit (ASIC), a field-programmable gate arrays (FPGA), a microprocessor coupled with memory that stores instructions executable by the microprocessor. The processor may comprise, but is not limited to, general purpose computer(s), special purpose computer(s), microprocessor(s), digital signal processor(s) (DSP) and/or multi-core processor(s).

The memory may comprise a software application module configured to process internal product specification and data, and manufacturing or production related data; an application module configured to process raw material data from external supplier(s); an application module configured to process an intermediate product-specific sustainability parameter; an application module configured to process an intermediate product-specific sustainability indicator. The memory may further comprise an application module configured to process life cycle parameter. Application modules may comprise computer executable instructions.

The memory may comprise means for processing internal product specification and data, means for processing manufacturing or production related data, means for processing raw material data from external supplier(s), and means for processing an intermediate product-specific sustainability parameter and -indicator. The memory may further comprise means for processing life cycle parameter.

The hardware and software components of the system may be located physically in one or more locations, they may make use of cloud based computing services or be arranged to use specifically written custom code or built by configuring suitable hardware and/or software platforms with pre-existing basic functionalities. Data transfer between the different system modules may be arranged using messaging, shared memory locations, databases or application programming interfaces (APIs) allowing modules to request and send information and data per need. All computing and communication modules may be back upped, protected by firewalls, encrypted or otherwise protected against unauthorized use via software or hardware-based mechanisms. Information and data may be protected against unauthorized changes using Block Chain-techniques to make sure that only verified and trusted data is used and conveyed further.

The communication unit may comprise means for receiving and transmitting data and information. Such means, or an arrangement configured to receive/transmit, may comprise wireless or wired communication link, bluetooth, short range communication link, internet, application programming interface (API), or alike. In addition or alternatively, it may include means for accessing a remote or external server, memory, device, database, data processing capacity or alike source. The communication unit may be arranged to communicate with internal source(s) of product specification and data, like manufacturing related data; with external sources(s), like external supplier(s) data and verification body.

The system is configured to receive internal product data from internal source(s) and raw material data from external supplier(s). The system is configured to process the received data with aid of the processor and data stored to the memory. The system may be configured to receive an intermediate product-specific sustainability parameter from a verification body in response to transmitting the received data to the verification body. The system is configured to produce an intermediate product-specific life cycle parameter based on the received data. The system is configured to combine the intermediate product-specific life cycle parameter and the intermediate product-specific sustainability parameter in order to form the intermediate product-specific sustainability indicator.

According to an embodiment, a computer program product for determining a sustainability indicator of an intermediate product is provided. The computer program product comprises a computer code. The computer code when executed by a processor causes a system at least to perform the following: receive a first input data 102, 202, 302 including internal information on the intermediate product, receive a second input data 104, 204, 304 including raw material information on the intermediate product from external supplier(s); process at least the first input data 102, 202, 302 based on a LCA model in order to form a life cycle parameter, process at least the second input data 104, 204, 304 in order to produce an intermediate product-specific sustainability parameter, optionally by transmitting at least the second input data 104, 204, 304 to an external verification body 106, 306 for processing and receiving an intermediate product-specific sustainability indicator 108 as a response from the external verification body; provide an intermediate product-specific sustainability indicator 108 comprising the intermediate product-specific life cycle parameter and the intermediate product-specific sustainability parameter and associate the intermediate product-specific sustainability indicator 108 for the intermediate product.

According to an embodiment, a computer program product for determining a sustainability indicator of an intermediate product is provided. The computer program product comprises executable instructions. The executable instructions when executed by a processor are configured to: receive a first input data 102, 202, 302 including internal information on the intermediate product, receive a second input data 104, 204, 304 including raw material information on the intermediate product from an external supplier(s); process at least the first input data 102, 202, 302 based on a LCA model in order to form an intermediate product-specific life cycle parameter, process at least the second input data 104, 204, 304 in order to produce an intermediate product-specific sustainability parameter, optionally by transmitting at least the second input data 104, 204, 304 to an external verification body 106, 306 and receiving the intermediate product-specific sustainability indicator 108 as a response from the external verification body; provide an intermediate product-specific sustainability indicator 108 comprising the intermediate product-specific life cycle parameter and the intermediate product-specific sustainability parameter, and associate the intermediate product-specific sustainability indicator 108 for the intermediate product.

The method according to this disclosure may be provided as a service. In such an embodiment the intermediate product is given a unique code, for example, per each manufacturing batch or lot manufactured using the same specification and raw materials arising from same sources. This code can then be used by the customer to request sustainability indicator or other relevant parameters from the system as a service and to be used further in customer's own calculations, systems or provided further. Such unique code may be coded, for example, into machine readable bar codes or QR codes and provided forward together with the physical product.

Intermediate products, such as label products, may be purchased by customers that provide their (final) product with the intermediate product. Intermediate product-specific sustainability indicator provides a tool for the customer to select an intermediate product that best suites to each customer product in order to produce a desired environmental impact. The customer, i.e. the intermediate product purchaser, may use values relating to sustainability indicator as such, or the values may be used via equivalents, as described above. The customer may use the values related to the intermediate product-specific sustainability indicator as part of their calculations, i.e. for calculating the overall customer product sustainability indicator. The customer may have a system capable of receiving the life cycle parameter and/or sustainability parameter transmitted by the system disclosed in here. The system disclosed in here may be capable of transmitting the life cycle parameter and/or sustainability parameter to the customer's system.

In many countries currently, there are laws and statutes which require that advertisements must be truthful, should not be deceptive or unfair, and must be evidence-based. These rules are often applied even more strictly in the field of environmental marketing. Any green or otherwise environmental claims regarding the product should be supported in competent and reliable manner, even with scientific evidence. For example, US Federal Trade Commission has provided Green Guides to guide companies to comply with this type of jurisdiction. The current solution is helping to comply with such rules providing well verified and numerical based information on sustainability of intermediate products. This will also help to make the advertisement of the intermediate or final products and goods fact based in addition to making the comparison and selection of the products easier.

1. A method for determining a sustainability indicator for an intermediate product, comprising
receiving a first input data (102, 202, 302) including internal information on the intermediate product,
receiving a second input data (104, 204, 304) including external information on raw material(s) used for the intermediate product,
processing at least the first input data (102, 202, 302) according to a life cycle assessment method in order to produce an intermediate product-specific life cycle parameter,
processing at least the second input data (104, 204, 304) in order to produce an intermediate product-specific sustainability parameter,
providing an intermediate product-specific sustainability indicator (108) comprising the intermediate product-specific life cycle parameter and the intermediate product-specific sustainability parameter, and
associating the intermediate product-specific sustainability indicator (108) for the intermediate product.

2. The method according to claim 1, wherein the processing of at least the second input data (104, 204, 304) comprises
transmitting at least the second input data (104, 204, 304) to an external verification body (106, 306) for processing, and
receiving the intermediate product-specific sustainability parameter as a response from the external verification body (106, 306).

3. The method according to claim 1, the life cycle assessment method being performed in accordance to ISO14040/44 and PAS2050 standards.

4. The method according to claim 1, comprising associating and transmitting the intermediate product-specific sustainability indicator (108) with each intermediate product.

5. The method according to claim 1, wherein the first input data (102, 202, 302) comprises information on at least one of: materials, manufacturing process phases, manufacturing parameters, physical parameters of the components of the intermediate product.

6. The method according to claim 1, wherein the second input data (104, 204, 304) comprises information on at least one of: geographical origin, type, manufacturing process phases of raw material.

7. The method according to claim 1, wherein at least the second input data (104, 204, 304), optionally with the first input data (102, 202, 302), is processed by apportioning carbon sequestered in the forest to the intermediate product.

8. The method according to claim 1, wherein the first input data (102, 202, 302) and/or the second input data (104, 204, 304) are received via one of: wireless or wired communication link, internet, radio network access, application program interface.

9. The method according to claim 2, wherein the data is transmitted to and/or received from the external verification body (106, 306) via one of: wireless or wired communication link, internet, radio network access, application program interface.

10. The method according to claim 1, wherein the intermediate product-specific sustainability indicator (108) is expressed via equivalent(s), the equivalent(s) being identified and correlated with environmentally positive effect(s).

11. A system (101, 201, 301) for determining a sustainability indicator for an intermediate product comprising
means for receiving a first input data (102, 202, 302) including internal information on the intermediate product,
means for receiving a second input data (104, 204, 304) including external information on raw material(s) used for the intermediate product,
means for processing at least the first input data (102, 202, 302) according to a life cycle assessment method in order to produce an intermediate product-specific life cycle parameter,
means for processing at least the second input data (104, 204, 304) in order to produce an intermediate product-specific sustainability parameter,
means for providing an intermediate product-specific sustainability indicator (108) comprising the intermediate product-specific life cycle parameter and the intermediate product-specific sustainability parameter, and
means for associating the intermediate product-specific sustainability indicator (108) for the intermediate product.

12. A system (101, 201, 301) for determining a sustainability indicator for an intermediate product comprising means for performing any of the methods according to claim 1.

13. A system (101, 201, 301) for determining a sustainability indicator for an intermediate product comprising
an arrangement configured to receive a first input data (102, 202, 302) including internal information on the intermediate product,
an arrangement configured to receive a second input data (104, 204, 304) including external information on raw material(s) used for the intermediate product,
an arrangement configured to process at least the first input data (102, 202, 302) according to a life cycle assessment method in order to produce an intermediate product-specific life cycle parameter,
an arrangement configured to process at least the second input data (104, 204, 304) in order to produce an intermediate product-specific sustainability parameter,
an arrangement configured to provide an intermediate product-specific sustainability indicator (108) comprising the intermediate product-specific life cycle parameter and the intermediate product-specific sustainability parameter, and
an arrangement configured to associate the intermediate product-specific sustainability indicator (108) for the intermediate product.

14. The system according to claim 13, comprising at least one processor, at least one memory and at least one communication unit.

15. A computer program product for determining a sustainability indicator for an intermediate product, comprising a computer code, wherein said computer code when executed by a processor causes a system at least to perform:
receive a first input data (102, 202, 302) including internal information on the intermediate product,
receive a second input data (104, 204, 304) including external information on raw material(s) used for the intermediate product,
process at least the first input data (102, 202, 302) according to a life cycle assessment method in order to produce an intermediate product-specific life cycle parameter,
process at least the second input data (104, 204, 304) in order to produce an intermediate product-specific sustainability parameter,
provide an intermediate product-specific sustainability indicator (108) comprising the intermediate product-specific life cycle parameter and the intermediate product-specific sustainability parameter, and
associate the intermediate product-specific sustainability indicator (108) for the intermediate product.

16. A computer program product for determining a sustainability indicator of an intermediate product comprising executable instructions when executed by a processor are configured to:
receive a first input data (102, 202, 302) including internal information on the intermediate product,
receive a second input data (104, 204, 304) including external information on raw material(s) used for the intermediate product,
process at least the first input data (102, 202, 302) according to a life cycle assessment method in order to produce an intermediate product-specific life cycle parameter,
process at least the second input data (104, 204, 304) in order to produce an intermediate product-specific sustainability parameter,
provide an intermediate product-specific sustainability indicator (108) comprising the intermediate product-specific life cycle parameter and the intermediate product-specific sustainability parameter, and
associate the intermediate product-specific sustainability indicator (108) for the intermediate product.

17. A service for determining a sustainability indicator of an intermediate product, wherein the service utilizes the method according to claim 1, and the service comprises associating a unique code with the intermediate product.
